(19) United States
(12) Patent Application Publication
(10) Pub. No.: US 2015/0120568 A1
(43) Pub. Date: Apr. 30, 2015

(54) ELECTRONIC TRANSACTION METHOD

(71) Applicant: DEUTSCHE POST AG, Bonn (DE)

(72) Inventors: Dirk Hagemann, Bonn (DE); Jochen Lampe, Hurtgemwald (DE)

(73) Assignee: DEUTSCHE POST AG, BONN (DE)

(21) Appl. No.: 14/394,446

(22) PCT Filed: Apr. 16, 2013
(86) PCT No.: PCT/EP2013/057859

§ 371 Date: Oct. 14, 2014

(30) Foreign Application Priority Data
Apr. 17, 2012 (EP) 12164365.4

(51) Int. Cl. G06Q 20/38; G06Q 20/32

(52) U.S. Cl. CPC G06Q 20/382; G06Q 20/322
USPC 705/64

(57) ABSTRACT

A method can include transmitting a plurality of encodings to a given computing device in a commercial transaction. The method can also include transmitting information characterizing an entity associated with the given computing device to another computing device in the commercial transaction. The method can further include transmitting a particular encoding of the plurality of encodings to the other computing device in the commercial transaction.

### FIELD OF THE INVENTION

The invention relates to an electronic method for approving a transaction, to a corresponding transaction system, to a transaction application for carrying out the method, to a mobile terminal having such a transaction application, and to a payment system comprising the transaction system.

### BACKGROUND OF THE INVENTION

Electronic methods that support business transactions, especially the payment of goods, are already in use worldwide. Such electronic methods permit, for example, cashless payments in a store using a payment card such as a giro debit card or a credit card. In order for such a payment by giro debit card or credit card to be possible, the store in question has to have an electronic card reader with which the payment card can be swiped and which is connected via a data line to a payment system, for example, of the company that issued the card, so that the payment can be transacted from the store. In order for such cashless payments to be possible, the stores in question have to make the requisite technical infrastructure available, that is to say, a data line that connects at least to the card company, and one or more appropriate card readers. In particular, small stores such as newsstands or else remotely located stores or mobile businesses are often not capable of providing the necessary technical infrastructure for such an electronic method. However, even if these businesses were to have the technical infrastructure, they would have to incur additional costs for this, which can be quite difficult, particularly for small businesses or for businesses with a low sales volume.

Therefore, a system or method would be desirable that, with a minimal technical infrastructure, can support business transactions specifically for small or mobile businesses. It would also be desirable if, in addition, this system or method were inexpensive to operate.

### SUMMARY OF THE INVENTION

An objective of the present invention is to provide an electronic method that is easy to handle and that can be used to approve a transaction within the scope of a business transaction between buyers and sellers, that can be used virtually without limitations in terms of location, that requires a minimum of already available technical infrastructure, and that is nevertheless secure for all parties involved.

This objective is achieved by an electronic method to securely approve a transaction within the scope of a business transaction between at least a first person and a second person via a mobile terminal belonging to the second person and having a display element that is connected to a transaction server of a transaction system via a wireless data connection for purposes of exchanging data in order to approve the transaction, said method comprising the following steps:
at least first user data of the first person as well as second user data of the second person are provided in the transaction system for purposes of access by the transaction server,
an identification module is provided by the first person at a business point of the first person, comprising information for the identification of the first person,
a plurality of transaction encodings is transmitted to the first person by the transaction system, whereby each of the transmitted transaction encodings differs unambiguously from the other transmitted transaction encodings,
the transmitted plurality of transaction encodings is stored in the transaction system and associated with the first user data of the first person,
a transaction application that is installed on the mobile terminal of the second person is started,
the information of the identification module is captured by means of the mobile terminal and a connection is automatically established between the mobile terminal and the transaction server, and the information of the identification module is automatically transmitted to the transaction server by the transaction application in response to the captured information of the identification module,
data for the personal identification of the first person is transmitted by the transaction server to the mobile terminal of the second person after the verification of the first person has been completed by the transaction server on the basis of the information transmitted to the transaction server,
transaction-relevant data is entered into the mobile terminal and at least this transaction-relevant data is transmitted by the mobile terminal to the transaction server,
a valid transaction encoding from among the plurality of transaction encodings associated in the transaction system with the user data of the first person is transmitted by the transaction server to the mobile terminal in response to the transaction-relevant data transmitted to the transaction server,
the transmitted valid transaction encoding is marked by the transaction server in the plurality of the stored transaction encodings associated with the user data as a transaction encoding that is invalid for subsequent transactions,
at least parts of the transmitted valid transaction encoding, together with the data for the personal identification of the first person, are displayed on the display element of the mobile terminal by the transaction application in order to allow the displayed transaction encoding and the data for the personal identification of the first person to be visually compared to the transaction encodings transmitted to the first person by the transaction server.

With this comparison, the completion of the transaction by the first person is made possible insofar as this comparison turns out to be positive, that is to say, if the displayed transaction encoding and the data for the personal identification match the first person and match the transaction encodings that have not yet been used up on the list of transaction encodings of the first person. In one embodiment, each transaction encoding comprises at least a first transaction code and a second transaction code. In a preferred embodiment, the first and second transaction codes are graphic codes that permit a simpler use while reducing the risk of a mix-up among various transaction codes or among the transaction encodings based on them. In another embodiment, the transaction application is transmitted by the transaction system to the mobile terminal, thereby ensuring that an essentially technical means for the execution of the method is readily available to the second person.

As a result, an electronic method that is easy to handle and that can be used to approve a transaction within the scope of a business transaction between buyers and sellers (first person and second person) is put forward that can be used virtually without limitations in terms of location (wireless connection between the transaction server and the mobile terminal), that requires a minimum of already available technical infrastructure (mobile terminal of the second person), and that is nevertheless secure (use of an unambiguous identification module for the first person, conveying unambiguous transaction encodings to the second person and displaying them so that they can be shown to the first person for purposes of making a comparison to corresponding transaction encodings of the first person that the first person has received ahead of time via some other modality). The term “mobile terminal” as used here encompasses all devices that have a display element, that are capable of maintaining a wireless data connection with the transaction server, and that have application and e-mail capabilities such as, for example, smartphones. The wireless data connection can be established, for example, via a mobile telecommunications network or a WLAN network. The method can be carried out for any desired number of first and second persons.

A transaction as set forth in the present invention is, for instance, the payment of the purchase price within the scope of a business transaction between the first person and the second person. Here, for example, the first person is the seller of a product and the second person is the buyer of this product. With the above-mentioned method, for instance, the buyer can effectuate the verified payment of the purchase price (the transaction) to the seller so that the business transaction can be completed by the first person on the basis of the verification that the seller can see in the mobile terminal. In this context, the content of the invention is not the business transaction between the first person and the second person, but rather the technical method for carrying out and verifying a transaction between the parties to the method by means of a technical transaction system. For this purpose, for example, the bank data of the first and second persons constitutes part of the first and second user data. However, the bank data of the second person would not be necessary if, within the scope of the transaction, the second person can make use of a credit in another form, for example, in that a monetary amount that is sufficient for the transaction has been previously deposited into a credit account in a system that is involved in the transaction. As a result of an approval based on the transaction, the payment of the purchase price can be made to the seller (first person). The transaction—here, for example, the payment—is authorized through the use of unambiguous and characteristic transaction encodings. The second person identifies himself or herself by starting the transaction application in that, for example, the start of the transaction application requires the entry of a password, a PIN code or else other or additional features for his or her unambiguous identification on the mobile terminal. During the start procedure of the transaction application, for example, an appropriate input window opens up, for instance, on the display element of the mobile terminal so that data authorizing the second person, here the buyer, to execute the transaction application can be entered. On the basis of the communication of the transaction application—which has been started with authorization—with the transaction server and on the basis of the applicable second user data that is present in the system, the second person is unambiguously identified in the transaction system. Both parties to the method (first person and second person) are unambiguously identified vis-à-vis the transaction system by means of the identification method of the seller (first person), on the basis of the identification module that designates him or her, after which the information captured from this is transmitted to the transaction server by the transaction application. The information for the identification of the first person comprises characteristic data that is unambiguously associated with a specific first person. In this context, the characteristic data can be configured with different formats. For example, the characteristic data comprises an unambiguous alphanumeric sequence of characters that is likewise stored in the user data of a first person, and thus permits an unambiguous association of the characteristic data with a specific first person. The information that can be read out of the identification module has to comprise at least the characteristic data but, depending on the embodiment, it can comprise additional data. In one embodiment, the transaction application, which has been authorized to start, can use a characteristic key for identification to the transaction server for purposes of communication with the transaction server.

The identification module is provided with this (identifying) information, which designates the first person, at the business point of the first person. The term “business point” refers to a place where the transaction is carried out by means of the mobile terminal of the second person. Typically, this business point is synonymous with the place where the goods are handed over once the transaction has been completed. The term “provide” comprises any modality that makes it possible to capture information that is located on or in the identification module. In one embodiment, for example, the identification module is visibly attached in the vicinity of a cash register in a business establishment. It is also possible to use several identification modules to equip several cash registers. In another embodiment, in order to carry out the method according to the invention, the identification module is carried along by the first person and shown to the second person so that the latter can capture the information of the identification module with his or her mobile terminal. The transaction system can transmit the identification module to the first person, for example, electronically so that it can be printed out or else it can be sent through the regular mail. Preferably, the identification module is transmitted, together with the plurality of transaction encodings, to the first person. For example, the transaction server generates an identification module on the basis of the user data, and the transaction server either transmits this identification module to the first person electronically, or else the transaction server controls a generation module for the identification module that creates the identification module, for example, chips such as an NFC (Near Field Communication) chip or RFID (Radio Frequency Identification) chips that are integrated into the identification module as carriers of the information for the identification of the first person. The term “capture” refers to the capturing of information in any form, for example, by entering a sequence of characters into an input window provided by the transaction application, whereby these characters are visibly printed on the identification module so that they can be copied. However, the term “capture” also encompasses an automatic read-out procedure from a data memory in or on the identification module as well as the storage of the read-out data in the mobile terminal by the transaction application. In response to the capturing of the data, the transaction application, with the assistance of the mobile telecommunications modules or of other wireless communication modules in the mobile terminal, establishes a wireless data connection with the transaction server and transmits the captured information to said transaction server. The establishment of the connection and the transmission can be triggered automatically by acknowledging the entry into the input window or by some other type of read-out process. Moreover, the storage of the captured information by the transaction application can trigger the establishment of the connection and the transmission to the transaction server. The verification of the transmitted information constitutes a comparison of this information to all of the user data in order to associate the information with specific user data, whose association thus unambiguously identifies the first person. The data for the personal identification that is transmitted in response serves to clearly display the first person in the display element of the mobile terminal, for example, by means of explanatory information or differently shapes symbols. Via a display of this data for the personal identification, the second person can verify, for instance, whether the information of the information carrier has been properly captured and correctly transmitted to the transaction server. If, for example, the identification module is read out in a bakery A and if subsequently the logo of a shoemaker B is displayed in the display element of the mobile terminal as the data for the personal identification of the first person, then the second person recognizes that an error must have occurred. Conversely, after the display of the logo of the bakery A in the display element, the second person knows that the method according to the invention has proceeded error-free so far and he or she will then continue this method accordingly.

The continuation comprises entering transaction-relevant data such as, for example, a purchase price that is paid by carrying out the method according to the invention. In other embodiments, additional transaction-relevant data could be, for example, data supplementary to the purchase price such as an agreement on installment payments, the subtraction of discounts and/or the current date. As an alternative, in one possible embodiment, the customers themselves can scan the products in a store or can place them into a virtual shopping basket and pay for them later.

On the other hand, if this association of the information with specific user data (first person) by the transaction server were to fail, for instance, because the first person is no longer participating in the method according to the invention, then the transaction server sends a notification to the mobile terminal indicating that the method according to the invention cannot be carried out any further for this transmitted information. In case of a data transmission error, the transaction application can offer a renewed or alternative capture of the information from the identification module.

The start of the transaction application refers to the activation of this transaction application on the mobile terminal where this transaction application had been previously installed within the scope of a method that will be described below. The start can comprise entering one or more data items for the identification of the second person. The applicable input masks and their activation sequence are automatically made available on the display element of the mobile terminal by the transaction application after they have been activated.

By using a single mobile terminal that in and of itself is already sufficient for securely carrying out the method, in principle, the use of the method has no limitations in terms of location, as long as there is a wireless connection between the mobile terminal and the transaction server. This wireless connection is largely available on land and, if applicable, also in areas on the seas and in the air. In order for the transaction to be approved, user data pertaining to all of the participating users, in other words, at least first and second user data pertaining to a first person and to a second person, has to be stored in the transaction system. On the basis of this data, the transaction encodings are transmitted to the first person, wireless data connections are established between the mobile terminal and the transaction server in order to transmit data such as the information of the identification module, transaction-relevant data, valid transaction encodings, etc. and, in this manner, the completion of a transaction is made possible. This user data is stored, for example, in the transaction system in a user database which is connected to the transaction server and which the transaction server can access in order to carry out the method steps, as a result of which the user data is thus made available in the transaction system. The user data of the users of the transaction system, that is to say, the first and second persons, can be entered into the transaction system in different ways, for example, by means of an appropriate registration method.

The term “valid transaction encoding” refers to all of the transaction encodings from among a plurality of transaction encodings that were transmitted to a specific first person and that, in the method according to the invention, have not yet been transmitted by the transaction server to a mobile terminal of a second person. Consequently, the term “valid transaction encoding” refers to all of the transaction encodings that have not yet been used up by a transaction. After the valid transaction encoding has been transmitted, it will consequently have been used for a transaction and therefore will have become invalid for any further transactions. Accordingly, in the file from which the valid transaction encoding was taken, the transaction server marks said transaction encoding with a marker, for example, by setting a flag, by setting a checkbox or by setting a copy protection for this transaction encoding, so that the transaction server is prevented from once again taking the transaction encoding that has been thus marked from this list or file or from copying it and sending it to a mobile terminal.

At least parts of the transmitted valid transaction encoding, together with the data for the personal identification of the first person, are displayed on the display element of the mobile terminal by the transaction application, thereby making it possible to verify vis-à-vis the first person that the transaction has been effectuated. This verification is desired by the first person since the method steps up to that point had been carried out only by the second person on the mobile terminal of the second person. Fraudulent use is ruled out in that the displayed transaction encoding, which corresponds to a transaction encoding that is associated with the first user data and that is stored in the transaction system, is compared to the transaction encodings that had been transmitted by the transaction system directly to the first person for verification purposes. Thus, the seller can unambiguously recognize whether the display in the display element corresponds to one of his or her valid transaction encodings or whether the allegedly executed transaction has fraudulently been indicated as having taken place. Thus, for example, the seller can refuse to hand over the product to the buyer until the latter has made a valid payment. Conversely, if the buyer (second person) uses his or her mobile terminal to show the seller (first person) the confirmation of the transaction on the basis of the displayed valid transaction encoding, then the product can be handed over to the buyer. Thus, the business transaction can be carried out securely for both parties by using the electronic method according to the invention. The transaction encodings can even contain additional information such as consecutive numbers for a plurality of transaction encodings, etc., so that there is only a need to display the security-relevant part of the transaction encodings, that is to say, the part that unambiguously distinguishes the transaction encoding from other transaction encodings for that particular first person involved. Here, the transmitted valid transaction encoding can be displayed completely, for example, including a shopkeeper's symbol, as the data for the personal identification of the first person. If in contrast, only parts of the transmitted valid transaction encoding are displayed, then, for instance, the data for the personal identification is absent from the display.

In an alternative embodiment, the first person can also be selected on the mobile terminal on the basis of data that is transmitted by the transaction server to the mobile terminal. The data pertaining to the first persons is shown in a suitable form on the display element of the mobile terminal. This suitable form preferably comprises a symbol or logo that makes the business of the first person recognizable to the second person. In addition, depending on the embodiment and/or on the information requirements of the second person, additional data pertaining to the first person can also be displayed immediately, or else it can be displayed subsequently by clicking on the symbol or logo. The data pertaining to the first persons is available in the user data of the first persons. After the first person has been selected, the further method steps are carried out as described above.

In one embodiment, the information for the identification of the first person that is provided by the identification module comprises machine-readable information. This facilitates the procedure of capturing the information employing appropriate means of the mobile terminal. In a preferred embodiment, the machine-readable information is a two-dimensional matrix code that can be read out by a camera in the mobile terminal and/or an NFC chip that can be read out by an NFC reading module in the mobile terminal.

The term “two-dimensional matrix code” refers to a flat, generally rectangular arrangement of a light-dark pattern (typically a black-white pattern in order to increase the contrast), whose light-dark structure constitutes an encoding of data. The mobile terminal is equipped with a camera that is typical of such portable devices and with a suitable reading program (decoder) so that the encoded data of the matrix code can be read (decoded) and thus captured. An example of such a matrix code is the so-called QR code (Quick Response Code) that consists of a square matrix of black and white dots that represent the encoded data in binary form. A special marking in three of the four corners of the square prescribe the orientation of the QR code. The data in the QR code is protected by an error-correcting code. As a result, the QR code can still be read (decoded), even in case of a loss of up to 30% of the code. In order for the QR code to be readable by means of a mobile terminal, the mobile terminal has a camera and a decoder for the image of the QR code that was taken or captured by the camera. The QR code can be printed onto the identification module without any problem by means of any commonly used methods. However, like with barcodes, here it is also important for the contrast to be as high as possible, ideally black on white. Depending on the capabilities of the reading device employed (mobile terminal), an inverse display is also possible. The code can also be printed in color, and even in several colors. However, care must be taken to ensure that the QR code, when it is viewed as a halftone image or as a black-and-white image, has a uniform contrast. The image size of the QR code has no limits, as long as the reading device can capture the image so that it fills the format and so that it is differentiated. A link can be integrated into the QR code. In one embodiment, the QR code contains instructions for executing the transaction application in order to capture the information pertaining to the first person and in order to transmit the information to the transaction server. In other embodiments, the person skilled in the art can also use other codes as the two-dimensional matrix code on the identification module. The advantage of using a two-dimensional matrix code as the carrier of the information for the identification of the first person is that it makes it possible for the information to be machine-readable, so that manual transmission errors are ruled out and a quick data capture is ensured. In addition, identification modules that have a two-dimensional matrix code as the carrier of the information can be electronically generated and electronically sent to the first person in order to be printed out and displayed there, which permits a very simple and fast way to supply the first person with identification modules. Preferably, the identification module is transmitted, together with the plurality of transaction encodings that are likewise to be transmitted to the first person. Mobile terminals are normally equipped with a camera, so that, for purposes of being captured, the matrix code can be photographed with any conventional mobile terminal.

The term “NFC chip” refers to a data memory that makes data available by means of near field communication (NFC) for suitable reading devices. NFC is an international transmission standard for the contact-free exchange of data over short distances. NFC technology is based on the combination of smart card and contactless connection technologies. It operates in the frequency range of 13.56 MHz and offers a data transmission rate of 424 kilobits/sec at a range of only 10 centimeters. This is desirable so that the establishment of contact can be considered as permission for a transaction. The term “NFC reading module” refers to a suitable module in the mobile terminal with that can read out the NFC chip and thus the information stored on it pertaining to the first person. In order to read out the data, the mobile terminal is placed in the immediate proximity in front of the identification module that has the NFC chip or in direct contact with the identification module that has the NFC chip. In this process, the transaction application controls the NFC reading module in such a manner that the data received with the NFC reading module is captured by the transaction application and, if this data constitutes information for the identification of a first person, then this data is transmitted to the transaction server. Whether or not data received by means of NFC technology constitutes such data can be seen from the data structure and from the data content. For this purpose, the information for the identification of the first person comprises components that characterize this data as data that is suitable for transmission to the transaction server. The advantage of using an NFC chip as the carrier of the information for the identification of the first person is that the information is machine-readable, so that manual transmission errors are ruled out and the data can be captured even more quickly than with the matrix code, since here, the mobile terminal merely has to be held in front of or on the identification module, without a need for additional operating steps. Many mobile terminals nowadays are already equipped with an NFC reading module.

In another preferred embodiment, the identification module is a sticker that is suitable to be displayed at the business point of the first person, preferably comprising the matrix code on the surface of the sticker and/or an NFC chip in or on the sticker and/or an alphanumeric identification code that can be entered into the mobile terminal.

The term “sticker” refers to any form of more or less two-dimensional information carriers for representing the information for the identification of the first person. The sticker makes it easy to affix the identification module in many areas, for example, on a surface near a cash register, door, counter, etc., preferably onto flat surfaces. In this case, the sticker can be glued onto flat surfaces. Preferably, the sticker has an adhesive layer on the back. The back refers to the side that is not printed with the matrix codes or with alphanumeric character strings as the information. In addition, the color, shape and size of the sticker can be selected suitably so that it is configured to be so conspicuous that the second person quickly notices the identification module and can thus initiate the transmission of the information of the identification module more quickly. The sticker can be produced, for example, by a generation module as part of the transaction system that receives the necessary data from the transaction server. This transmission can automatically trigger a corresponding generation of the sticker. The sticker is then sent to the first person in a suitable manner, for example, through the regular mail. The postal data for the mailing is extracted from the user data by the transaction server and likewise transmitted to the generation module.

In another embodiment, the information of the identification module is photographed as a two-dimensional matrix code by actuating the camera of the mobile terminal, and the photographed matrix code is automatically evaluated by the previously started transaction application in response to the actuation of the camera. Here, either the transaction application has an appropriate decoder or else the transaction application accesses such a decoder that is installed on the mobile terminal. As an alternative, the information of the identification module is read out from the NFC chip by means of the NFC reading module of the mobile terminal, and said information is automatically evaluated by the previously started transaction application in response to the information provided by the NFC chip, or else the alphanumeric identification code located on the identification module is entered into an input window provided by the transaction application. In the above-mentioned cases, the information evaluated and/or entered or captured on the mobile terminal by the transaction application is transmitted to the transaction server.

In one embodiment, at least parts of the transaction encoding, together with the data for the personal identification of the first person, are displayed on the display element of the mobile terminal and stored as an electronic record (receipt) of the transaction, at least by the transaction application, on the mobile terminal of the second person. This information, which is stored in an appropriate electronic file, serves as an electronic receipt of the transaction. The second person shows this receipt to the first person and then receives, for example, the product that has been paid for by means of this method. Moreover, the first person can unambiguously ascertain by means of the receipt that the executed transaction relates to a transaction that is indeed meant for the first person. For this purpose, in one embodiment, the receipt contains the entire transaction encoding that comprises the first and second transaction codes of this transaction encoding and that was transmitted during the data traffic between the mobile terminal and the transaction server. By making a comparison to the first transaction encoding on the list of transaction encodings, the first person can once again verify the receipt, together with the likewise present data for the personal identification. In this manner, the display of the receipt in the display element increases the transaction security for the first person and, at the same time, can be used by the second person for subsequent processes.

In one embodiment, the method comprises the additional step of registration of at least the first and second persons in the transaction system in order to generate first and second user data. The number of first and second persons is not limited here. The expressions “first person” and “second person” as set forth in the invention refer only to the role assignment during the execution of the method steps and these terms do not constitute a numerical limitation of the number of users. Here, for example, the first and second user data can be entered by reading in user data sheets or by entering user data on the basis of data provided by the users (first and second persons) at the time when a user registers in the transaction system.

In a preferred embodiment, the registration of at least the first person is carried out via a website of the transaction system, whereby at least the first person provides data. For this purpose, for example, a first person activates an Internet-capable terminal device such as, for example, a laptop, a PC, a notebook or a smartphone, and opens the address of the website of the transaction system in a browser, so that, by clicking on an appropriate field, the registration process for the transaction system is started. Within the scope of the present invention, the person skilled in the art is capable of providing a suitable registration process for the transaction system on a website. As a network having one or more transaction servers with an Internet connection, the transaction system can also comprise, for instance, one or more computers that provide the website (in a web portal) and that are connected to the transaction server(s) and, if applicable, to the additional components of the transaction system. In a client-server network, the transaction servers are the servers (backend), whereas the computers by means of which the first and/or second persons use the website of the transaction system are the clients (frontend). Whenever the term “transaction server” is used within the scope of this invention, this always includes the possibility of using several transaction servers.

In one embodiment, a three-stage registration process is performed, whereby in a first step, personal data of the first person is entered such as, for example, the name of the person and/or the name of a company, the associated address, if applicable, additional data such as the contact person at the company, the business sector of the first person (e.g. flower store, bakery shop, newsstand, etc.), a marking of the position of the first person or company on a virtual map (e.g. via a Google Maps application incorporated into the website), and this data is confirmed at the end of the entering procedure. In one embodiment, when the business sector is entered, the website shows graphic symbols to the first person that the first person can select in order to indicate his or her business sector. In this embodiment, the selected symbol can be used in order to generate a personal identification or else as the personal identification of the first person, said personal identification being transmitted by the transaction server to the mobile terminal during the course of the method as the data employed for the personal identification. The data for the personal identification can be incorporated in part into the transaction encodings that themselves are to be generated later, for example, in a generating means for generating transaction encodings, and this data can be stored in a memory to which the generating means has access and it can then be used. In this embodiment, the personal identification of the first person is a graphic personal identification. As an alternative, the personal identifications of the first persons can also be stored in the first user data in a user database that the generating means accesses in order to generate the transaction encodings and in order to incorporate the data for the personal identification into the transaction encodings. In another embodiment, the first person can also use the website to upload his or her own graphic symbol (e.g. a company logo) into the transaction system as his or her desired personal identification. The storage and access to the data for the personal identification can then be configured as described above. Each first person has an unambiguous personal identification that differs from every other personal identification of other first persons, and this constitutes unambiguous data for the personal identification.

As the second step of the registration, the data of the first person that is relevant for the transaction can be entered into the transaction system via the website. For example, if the transaction involves the payment of a purchase price, account data such as the name of the account holder, the name of the bank where the account is held, the account number and the bank routing number are all entered. In order to complete the second step, the entered data is confirmed by the first person by clicking on an appropriate field on the website, and then this data is transmitted to the databases, to the memory locations and/or to the transaction server. In one embodiment, a plausibility check is carried out when the transaction-relevant data is entered in order to prevent that a transaction that is subsequently approved cannot be executed because of erroneous user data.

As the third step, in one embodiment, a user name can be issued with an associated access authorization (account). The user name and the access authorization (e.g. password) are stored in the user data and transmitted to the transaction server.

After the registration process (registration) has been completed, the first person can generate a plurality of transaction encodings from his or her thus-activated account by clicking on an appropriate field on the website. As an alternative, in one embodiment, the transaction system automatically generates the plurality of transaction encodings for the registered first person for transmission to the first person after the registration has been completed. This plurality of transaction encodings can be configured in the form of an electronic list, for example, as an electronic list in a pdf format, Word format or Excel format, whereby the individual transaction encodings each contain a personal identification of the first person. In another embodiment, the transaction encodings also comprise a first transaction code and a second transaction code, whereby each of the transaction encodings in this generated list differs unambiguously from the other transmitted transaction encodings, at least in terms of having different first and/or second transaction codes. Within the scope of the present invention, the person skilled in the art can select a suitable format for the first and second transaction codes. In one embodiment, first and second transaction codes are graphic codes such as, for example, graphic symbols. Such graphic codes (symbols) are easy to recognize and to communicate, which translates into a reduced error rate during the transmission of the transaction encodings and of the subsequent approval of the transaction (or its refusal). However, it is also possible to issue graphic-acoustic codes (symbols) that improve the recognition rate and reduce the error rate. The list of transaction encodings can be configured in different ways within the scope of the present invention. The generated transaction encodings can be generated, for example, as a list with lines, columns, and a shared general header, whereby, for instance, the data for the personal identification of the first person is displayed in the shared header. Since the first person is designated to carry out the further method steps after the capture and transmission of the information of the identification module, and since, for example, several transactions could be carried out consecutively with this person, such a list of transaction encodings only requires a one-time indication of the personal identification in the header. The header can be divided into several sections containing additional information such as, for example, personal data, etc. Moreover, in a first column, the list of transaction encodings can contain numbering for the further combinations of first and second transaction codes according to the first, second, third, . . . transaction encoding, whereas the corresponding first and second transaction codes are indicated in the second and third columns. Preferably, the first and second transaction codes are graphic symbols that permit a secure use of this list in printed-out form by the first person, even from a certain distance. For example, the list with the transaction codes is displayed behind a store counter and the information of the graphic first and second transaction codes on the list is securely compared to the information of the mobile terminal from a certain distance in order to carry out the further method steps, which, in the case of a purely alphanumeric encoding, would lead to a high error rate during the data entry (supplementation) into the mobile terminal. The use of graphic symbols as the first and second transaction codes (graphic transaction codes) accounts for a reduced error rate during the data entry within the scope of the method according to the invention and thus to a faster approval of the transaction by the transaction system. In one embodiment, the list with the plurality of transaction encodings has at least one additional column designed, for example, for entering monetary amounts for transactions that constitute payments. This list of transaction encodings can comprise a different number of transaction encodings, for example, 20 or 100 different transaction encodings. Depending on the embodiment, the number of transaction encodings can be predetermined by the transaction system or else it can be selected by the first person, for example, by means of an appropriate selection field on the website, in such a way that it meets the requirements of the first person.

In one embodiment, the first person can request or configure the identification module via the website of the transaction system. For this purpose, the first person can indicate how the identification module should be configured, for example, whether it should be furnished with an alphanumeric code and/or a matrix code and/or an NFC chip in order to provide the information for the identification of the first person. On the basis of the user data, the transaction server can transmit the identification module to the first person—either in electronic form or as a postal mailing, depending on the configuration—for instance, together with the transaction encodings or separately from them, in the same manner or in a different manner.

As an alternative, the plurality of transaction encodings of the first person can be made available as a printable list. The printing procedure can be carried out or initiated, for example, via the website by clicking on an appropriate printing field. In one embodiment, the plurality of transaction encodings is transmitted by the transaction system to the first person in that the transaction encodings are printed out on a printer of the first person. In an alternative or supplementary embodiment, the transaction encodings and, if applicable, additional communications to be carried out between the transaction system and the first person, can be transmitted via a smartphone of the first person. For this purpose, an appropriate first-person application that permits a transmission is installed on the smartphone of the first person. This first-person application can be made available to the first person, for example, via an application memory. If the identification module is transmitted in electronic form, the first person can print this out in the same way as in the case of the transaction encodings.

The one-time registration of the second person can likewise be carried out via the website of the transaction system in that the second person provides data. For example, in order to do so, the second person activates an Internet-capable terminal device such as, for example, a laptop, a PC, a notebook or a smartphone, and opens the address of the website of the transaction system in a browser, so that the registration process for the transaction system is started by clicking on an appropriate field. Within the scope of the present invention, the person skilled in the art is capable of providing a suitable registration process for the transaction system.

In an alternative embodiment, the transaction application is transmitted to the mobile terminal of the second person by downloading the transaction application, for example, via a direct link of the mobile terminal with the browser of the website of the transaction system, or from a website that offers applications for downloading (e.g. a so-called app store). The second person installs the transaction application on the mobile terminal, for instance, after downloading it. In a preferred embodiment, the transaction application automatically installs itself on the mobile terminal after it has been downloaded onto the mobile terminal. This automatic installation can also take place if, as an alternative, the transaction application was uploaded onto the mobile terminal, for example, from a memory chip or a CD-ROM. In order to download the transaction application, it is not absolutely necessary for the second person to have previously registered with the transaction system.

In one embodiment, a first boot of the transaction application installed on the mobile terminal automatically starts the step of registration of the second person once a wireless data connection to the transaction server has been established. In a preferred embodiment, contact data for establishing the wireless data connection is automatically transmitted by the transaction application to the transaction server. This registration of the second person can consist of a multi-stage registration process. The transaction application first downloads a registration form from the transaction server. The second person (e.g. the later buyer of a product in a store) enters his or her name, e-mail address, etc. into the electronic form. The provision of a regular mailing address might be necessary, depending on the payment method, for instance, in case of an electronic direct debit procedure. In order to carry out the method, the second person has to have a valid e-mail address to which the further transmissions can be sent later on by the transaction server. This information serves to identify the second person in the transaction system. Moreover, the second person can generate an access authorization, for example, a four-digit security PIN, whereby, in order to carry out the method according to the invention, the transaction application on the mobile terminal of the second person can only be started after the correct PIN has been entered. Then, in order to complete the first step, the entered data is confirmed by the second person by clicking on an appropriate field on the electronic form. In the next step, the second person can enter his or her transaction-relevant bank data into the electronic form. For example, in the case of the payment of a purchase price as the transaction that is to be approved, the account data is entered such as, for example, the name of the account holder, the name of the bank where the account is held, the account number and the bank routing number. The present invention can also be used for alternative payment systems. For example, with Giropay, funds can be added in order to use the method according to the invention. In order for the payment transaction to be completed, the necessary data for logging in to the mobile bank account of the first person would then have to be entered, along with a secret user name and a PIN. If the use of the electronic direct debit procedures is desired, additional identification measures for the second person might be necessary, which is why, in this step, additional data would have to be entered for the second user data. In each case, the payment is made after approval by the transaction system. In order to complete the second step, the entered data is confirmed by the second person by clicking on an appropriate field on the electronic form. In one embodiment, a plausibility check is carried out when the relevant user data is entered in order to prevent that the transaction that is subsequently approved cannot be executed because of erroneous user data. The entered data is transmitted to the transaction server either step by step or all at once.

In order to complete the registration, the second person receives an e-mail from the transaction server containing a secure confirmation link, which the second person follows. Via this link, the second person reaches a secure web page generated only for that individual second person (subsequent other second persons receive an appropriate link to a different web page). The transaction system identifies the second person and associates the e-mail address with the second user data. The transaction system now has the complete second user data of the second person. The registration process is hereby completed. From this point on, the transaction application can be used to carry out the method according to the invention.

In another embodiment, the transaction application permits the verified reversal of the transaction by providing a cancellation procedure using one of the still-valid transaction encodings from the plurality of transaction encodings that were transmitted to the first person. The verified reversal refers to a procedure in which the first person and the second person are involved, so that just one person alone cannot initiate a fraudulent reversal. The cancellation procedure refers to a procedure in which an executed transaction is balanced out on the books by means of a credit transaction. In this context, only already booked positive transactions can be cancelled. The term “reversal” of a transaction as set forth here means that the transaction in question remains stored in the system as such, but that its consequences are taken back, for example, by a credit that equalizes the transaction. After such a credit, the “reversed” transaction remains booked in the system and is offset by the credit.

In a preferred embodiment, the cancellation procedure (SV) comprises the following steps:
a cancellation request for a specific transaction is transmitted by the transaction application to the transaction server, after an entry to this effect has been made on the mobile terminal,
a cancellation identification code is transmitted that relates to a specific transaction code among the plurality of transaction encodings transmitted to the first person, whereby each of the transaction encodings comprises first and second transaction codes that unambiguously differ from the first and/or second transaction codes of other transaction encodings, and this cancellation identification code is displayed in the display element,
the first and second transaction codes, preferably graphic transaction codes, of the transaction encoding designated by the transmitted cancellation identification code are entered into the mobile terminal by the first person on the basis of the plurality of transaction encodings that were transmitted to the first person and that comprise the transaction encoding designated by the cancellation identification code,
the entered first and second transaction codes are transmitted to the transaction server,
the reversal of the specific transaction is verified by the transaction server in that the first and second transaction codes transmitted by the mobile terminal are compared to the stored transaction encoding that comprises the first and second transaction codes stored for this purpose and that is associated with the user data of the first person and with the cancellation identification code, and
the transaction is reversed in case of a positive comparison by generating a cancellation credit.

For this purpose, in one embodiment, the second person can enter, for example, the security PIN in order to activate the above-mentioned method steps for the cancellation. In order to do so, the second person (customer) selects an appropriate field from a menu of the transaction application, enters the security PIN and confirms the entry. This entry is then verified by the transaction server or by the transaction application. In one embodiment, the second person subsequently makes additional entries pertaining to the transaction that is to be reversed or cancelled, these entries being made in appropriate fields offered by the transaction application on the display element. After the confirmation, the transaction application automatically transmits the transaction data as a cancellation request to the transaction server. In a preferred embodiment, the electronic record for the specific transaction is transmitted as a cancellation request to the transaction server, said record having been previously stored in the mobile terminal by the transaction application. In one embodiment, after the second person has called up the cancellation procedure, he or she can search through the stored electronic records (receipts) in order to find the record of the transaction that is to be reversed and in order to select the appropriate electronic record for the cancellation request.

After the cancellation request has been transmitted to the transaction server, the transaction server then selects a transaction encoding that is still valid (i.e. a transaction encoding without an appropriately set “invalid” marker) from the plurality of transaction encodings transmitted to the first person. In addition to the transaction codes and to the data for the identification of the first person, the transaction encodings also each comprise a consecutive number or characterizing numbers or letters as a designation. This designation is transmitted to the second person as the cancellation identification code and is displayed clearly visibly by the transaction application in the display element of the mobile terminal. In the example of a “49” as the cancellation identification code, the second person shows the displayed number “49” to the first person or informs the first person of this number. The same applies to other designations as cancellation identification codes, for instance, as code “B” or something else. The list of transaction encodings that the first person had received from the transaction server contains this transaction encoding with the designation “49” (or “B”). In this embodiment, the transaction encodings comprise a first and a second transaction code, whereby all of the transaction encodings that were transmitted to the first person differ in terms of the first and/or second transaction code. Preferably, the first and second transaction codes are graphic symbols that make a transmission simple, easy to recognize visually and therefore more secure against being mixed up. On the basis of the cancellation identification code, the first person informs the second person about the appropriate first and second transaction codes from the list of transaction encodings, each of which is designated by different cancellation identification codes, so that the second person can enter into the mobile terminal the appropriate and correct transaction codes that belong to this transaction encoding. The transaction application transmits these entered transaction codes to the transaction server, which then checks whether the entered transaction codes match the transaction codes that, from among the transaction encodings transmitted to the first person, are contained in the user database in the transaction encoding that is designated by the cancellation identification code that was transmitted to the mobile terminal. In order to be able to make the comparison, the transaction server marks the transaction encoding in the list of stored transaction encodings whose designation had been transmitted to the mobile terminal as the cancellation identification code. This comparison corresponds to the verification of the cancellation or to the reversal of the transaction. If the comparison reveals a match between the expected transaction codes for the marked transaction encoding in the list of transaction encodings in the transaction system and the transaction codes entered via the mobile terminal, then the comparison is positive and the transaction is reversed (cancelled). Otherwise, the transaction server sends an error message to this effect to the mobile terminal. For example, if at least 10 different first transaction codes and at least 10 different second transaction codes are in use for configuring the transaction encodings, then this virtually rules out the possibility of fraudulent use of the cancellation procedure by the second person through the modality of unauthorized guessing of the correct transaction codes for a cancellation of the transaction that is not wanted or permitted by the first person. In order to further increase the security against unauthorized cancellation, the number of entry attempts of transaction codes for a cancellation request can be limited, for example, to three entry attempts. Reaching the maximum permitted number of entries for the two transaction codes can be recorded by the transaction server, so that, at the maximum number of negative comparisons, the cancellation for the cancellation request in question is blocked by the transaction server. In this case, a cancellation can only be manually carried out directly by the customer service.

In one embodiment, the first and second transaction codes are entered into the mobile terminal by making a selection from a number of possible first and second transaction codes that are displayed in the display element. Preferably, for purposes of this selection, the first and second transaction encodings are each arranged in the display element on first and second virtual dials that can be used to scroll up and down accordingly. In principle, such a dial can display any desired number of different transaction codes consecutively, so that the system security can be greatly increased while, at the same time, allowing a clear overview. The selection of two specific codes with two such dials is also user-friendly.

In one embodiment of the method, at the end of every day, the transaction system sends an automatic e-mail to the second person listing the transactions effectuated by the second person on this day in the form of documentation that also indicates the first person and the time of day. Owing to the automatic feedback to the second person, this person has a documented overview of the transactions that have been executed. Moreover, this reduces the risk of fraudulent use. In the case of erroneous transactions, if applicable, the second person can contact the transaction system and/or the first person for clarification. The transaction system stores the transaction encodings that were already used for approvals. Thus, a first part of a transaction encoding that had already previously been transmitted to the mobile terminal of a second person cannot be transmitted again to the same person or to another second person in order to approve another transaction. Consequently, each transaction encoding can only be used once for approval, which further increases the security of the approvals.

The invention also relates to a transaction application that is stored on a storage medium and that is suitable for carrying out the method according to the invention in conjunction with a transaction system according to the invention. Here, the transaction application can be transmitted to the second person on external data carriers such as, for example, a SIM card, chips, memory sticks, CD-ROMs, etc. for purposes of installation on the mobile terminal, or else the second person himself or herself can download the transaction application from the transaction system or from a website that distributes applications. Since the transaction application carries out numerous essential components of the transaction approval, there is also a need for the transaction application itself to be secured.

The invention also relates to a mobile terminal having a display element that can be connected to a transaction server of a transaction system according to the invention via a wireless data connection for purposes of data exchange, whereby a transaction application according to the invention is installed on the mobile terminal and can be executed on the mobile terminal. The term “mobile terminal” as used here encompasses all devices with a display element that are able to maintain a wireless data connection with the transaction server and that have application and e-mail capabilities such as, for example, a smartphone. The wireless data connection can be established, for example, via a mobile telecommunications network or a WLAN network. In one embodiment, the mobile terminal has a camera that is suitable for photographing two-dimensional matrix codes and/or an NFC reading module that is suitable for reading out an NFC chip. With such a mobile terminal, the information for the identification of the first person can be read out of the identification module simply, quickly and error-free.

The invention also relates to a transaction system to approve a transaction within the scope of a business transaction between at least a first person and a second person, comprising an application memory for storing a transaction application according to the invention, a user database for storing at least first user data of the first person and second user data of the second person, a generating means for generating transaction encodings, preferably comprising a first transaction code and a second transaction code, especially preferably the first and second transaction codes are graphic transaction codes, also at least one identification module for providing information for the identification of the first person at a business point of the first person, and comprising a transaction server that is connected via data lines at least to the application memory, to the user database and to the generating means, and that can be connected to a mobile terminal of the second person, and that is configured to
provide at least the first and second user data,
use suitable data transmission means to transmit a plurality of generated transaction encodings to the first person, whereby each of the transmitted transaction encodings differs unambiguously from the other transmitted transaction encodings, and
establish a wireless data connection with the mobile terminal of the second person,
whereby the mobile terminal is configured in such a way that, after the start of the transaction application installed on the mobile terminal, it captures the information of the identification module and automatically establishes a connection with the transaction server and automatically transmits the information of the identification module to the transaction server by the transaction application in response to the information of the identification module captured by means of the mobile terminal, after which the transaction server is configured to transmit data for the personal identification of the first person to the mobile terminal of the second person after the verification of the first person has been completed by the transaction server on the basis of information transmitted to the transaction server, whereby
the mobile terminal and the transaction application are configured to permit the entry of transaction-relevant data into the mobile terminal as well as the transmission of at least this transaction-relevant data from the mobile terminal to the transaction server,
the transaction server is configured so that a valid transaction encoding from among the plurality of transaction encodings associated in the transaction system with the user data of the first person is transmitted to the mobile terminal in response to the transaction-relevant data that was transmitted to the transaction server, and to mark the transmitted valid transaction encoding in the plurality of stored transaction encodings as a transaction encoding that is invalid for subsequent transactions, and
the transaction application and the mobile terminal are configured to display at least parts of the transmitted valid transaction encoding, together with the data for the personal identification of the first person, on the display element of the mobile terminal, so that the displayed transaction encoding and the data for the personal identification of the first person can be visually compared to the plurality of transaction encodings that were transmitted to the first person by the transaction server and so that the transaction can thus be completed by the first person.

In one embodiment, the transaction server is configured to use suitable data transmission means to transmit the transaction application to a mobile terminal of the second person. This direct transmission avoids the need for additional actions on the part of the user in order to the start up the transaction application and is consequently user-friendly. Preferably, the transaction application installs itself directly onto the mobile terminal after being transmitted. Preferably, the transaction application transmits to the transaction server the data needed to connect to the mobile terminal. In this manner, at the same time, the required wireless connection between the mobile terminal and the transaction server can be verified.

In one embodiment, the transaction system comprises a website for at least the first person to be registered in the transaction system and for data to be entered at least by the first person in order to generate first user data. The website for the registration, however, can also be used by other persons for such a registration procedure. Preferably, however, the second persons register themselves via the transaction application after its first boot on the mobile terminal.

An advantage of the transaction system according to the invention is the minimal number of electronic devices that the first and second persons are required to have, as described above. The first person merely needs a plurality of transaction encodings, which are transmitted by the transaction system. The manner in which the first person receives or obtains this list can be configured in different ways. This transmission can be made to an electronic device of the first person, for example, an Internet-capable laptop, a computer, a smartphone, etc. As an alternative, the transaction system can also send the plurality of transaction encodings as a list in paper form to the first person via regular mail, so that the first person does not need any electronic device at all in order to receive the list. For the approval of a transaction, when first and second user data is available, the method according to the invention only requires the second person to have a mobile device with a data connection to the transaction server of the second person. Consequently, the transaction system can be used by any first person, irrespective of the equipment he or she has. Therefore, the method according to the invention is particularly advantageous for first persons who run a small business, perhaps in a cramped space, and who nevertheless wish to offer their customers (second persons) better service by permitting electronic transaction approvals, for example, cashless payments. Since the method supports the execution of all kinds of transactions, especially all kinds of different payment systems and modes of payment through the approval modality and, if applicable, additional support through the subsequent execution and indication of the transaction to third parties involved in the transaction (e.g. banks of the first and second persons), this method is also advantageous for the second persons. They can, for example, make cashless payments where this had not been possible until now because the first persons did not have adequate equipment.

The invention also relates to a payment system having a transaction system according to the invention, having at least one mobile terminal according to the invention that is connected to the transaction system via a wireless data connection in order to carry out a method according to the invention, and having at least one money management system that is connected to the transaction system in order to execute the transaction between the first and second persons after approval by the transaction system, whereby the approval is sent to the money management system by the transaction system in response to the valid transaction encoding transmitted to the mobile terminal. Money management systems as set forth in the present invention are, for example, banks where first and second persons have accounts. In the payment system according to the invention, for example, the first person can also keep an electronic cash book in this manner. For this purpose, the transaction system sends to the second persons a list of the executed transactions, along with information pertaining to the transaction data (for instance, the amount to be booked for a cashless payment stemming from the approved transaction, the time of day, etc.). The first person can receive this list from the transaction system as an electronic list of transactions to be effectuated (for example, payments to be effectuated) and the first person can enter the amounts actually received in the account of the first person into appropriate fields in this list. In this manner, the first person can keep an electronic cash book. This electronic cash book is kept, for example, under the account of the first person on the website of the transaction system. In order to keep the electronic cash book, all that the first person needs is precisely the same technical devices that he or she also needs for the transmission of the plurality of transaction encodings. As an alternative, the first person can also keep the electronic cash book using the first-person application on his or her smartphone.

### BRIEF DESCRIPTION OF THE FIGURES

These and other aspects of the invention are shown in detail in the figures as follows:

FIG. 1 an embodiment of the transaction system according to the invention;

FIG. 2 an embodiment of the transaction encodings to be transmitted;

FIG. 3 an embodiment of the capture of the information for the identification of the first person on the basis of the identification module;

FIG. 4 an embodiment of the mobile terminal for entering the transaction-relevant data;

FIG. 5 an embodiment of the mobile terminal and of the display of the valid transaction encoding for the completion of the transaction;

FIG. 6 an embodiment of the mobile terminal for the cancellation procedure according to the invention;

FIG. 7 an embodiment of the transaction codes displayed in the display element of the mobile terminal as well as their selection in the display element;

FIG. 8 an embodiment of the method according to the invention;

FIG. 9 an embodiment of the cancellation procedure;

FIG. 10 an embodiment of the registration process according to the invention;

FIG. 11 an embodiment of a payment system with a transaction system according to the invention and a money management system for carrying out the transaction after the approval according to the invention.

### DETAILED DESCRIPTION OF THE EMBODIMENTS

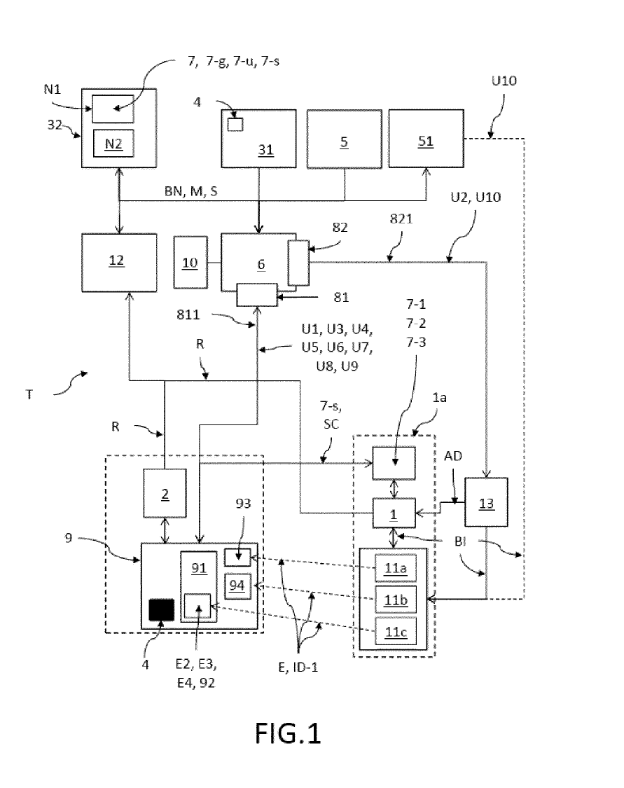

FIG. 1 shows an embodiment of the transaction system T according to the invention in conjunction with a mobile terminal 9 of a second person 2 as well as a transaction application 4 installed on it in order to approve a transaction within the scope of a business transaction between at least a first person 1 and a second person 2. The data connection between the transaction system T and the mobile terminal 9 of the second person 2 is established via a wireless data connection 811 to the transaction server 6 using appropriate data transmission means 81. In order for the transaction system T to be able to carry out the method according to the invention and in order for it to also initiate the transaction after the latter has been approved, the transaction system T needs user data N1, N2 of the first person 1 and of the second person 2 that the transaction server 6 can access via data connections between the components of the transaction system T. In order for it to be possible for the user data N1, N2 to be entered into the transaction system T, in this embodiment, said transaction system T comprises a website 12 for registering R at least the first person 1 in the transaction system T and for entering data by at least the first person 1 in order to generate first user data N1. This website 12 is provided, for example, by the transaction server 6 via the Internet or on client computers that are connected to the transaction server 6. The website 12 is also suitable for registering R the second person 2 so that he or she can enter user data N2 pertaining to said second person 2. As an alternative, the second user data N2 can also be transmitted by the mobile terminal 9—if applicable, during the execution of the transaction application 4—to the transaction server 6 via a wireless data connection 811 using the data transmission means 81. The user data N1, N2 is stored in a user database 32 in the transaction system T to which the transaction server 6 has access via data connections.

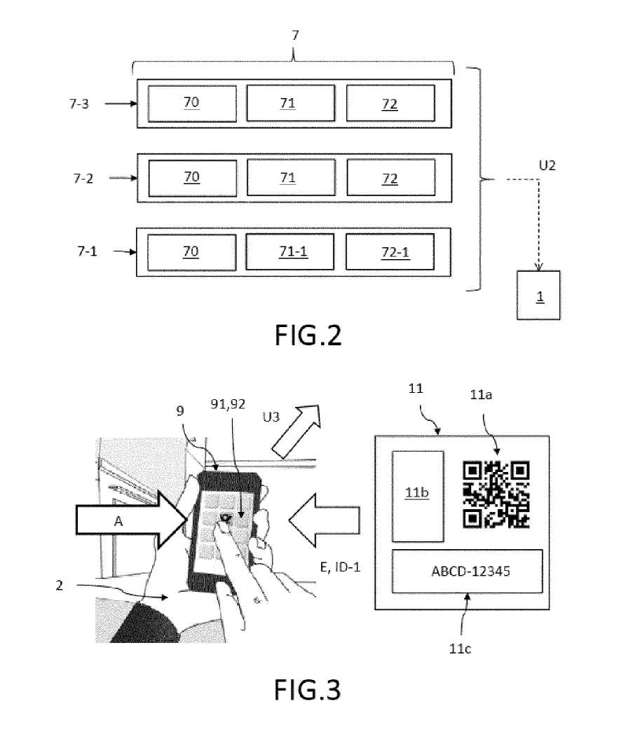

In this embodiment, the transaction server 6 is additionally connected via a data transmission means 82 and via a data connection 821 to a printer 13 of the first person 1. In this embodiment, a plurality (7-1, 7-2, 7-3, . . . ) of transaction encodings 7 are transmitted U2 by the transaction server 6 to the first person via this data connection 821. Preferably, the transmission U2 of the plurality of transaction encodings 7 to the first person 1 is carried out by printing out AD the transaction encodings 7 on the printer 13 of the first person 1. The transaction encodings 7 are generated with a generating means 5 that is connected to the transaction server 6 via a data line in order to transmit the transaction encodings 7. In one embodiment, the transaction encodings 7 each contain a personal identification 70 of the first person 1, a first transaction code 71, preferably a graphic first transaction code 71, and a second transaction code 72, preferably a graphic second transaction code 72, as is also shown in detail in FIG. 2. Each of the transaction encodings 7 transmitted U2 to the first person 1 differs unambiguously from the other transmitted transaction encodings 7, at least in terms of having different first and/or second transaction codes 71, 72. The plurality of transaction encodings 7 transmitted to the first person are stored in the transaction system T and associated with the first user data N1 of the first person 1. This applies to all of the unused, still-valid transaction encodings 7-g, to all of the transaction encodings 7-u that have been marked as being invalid after a transaction, and to all of the transaction encodings 7-s that might have been used for any cancellation procedures.

The application memory 31 is also provided in order to store the transaction application 4 so that it can be downloaded from the transaction system T via the transaction server 6 or else transmitted in some other manner to the mobile terminal 9 in order to be installed there so that the method according to the invention can be carried out. For this purpose, the transaction server 6 is equipped with suitable data transmission means 81 to transmit U1 the transaction application 4 via the wireless data connection 811 to the mobile terminal 9 of the second person 2. Via this data connection 811, the transaction server 6 also transmits U4 the data 70 for the personal identification of the first person 1 after the transmission U3 of the captured information for the identification of the first person. The information ID-1 for the identification of the first person 1 is provided by the identification module 11. This information ID-1 can comprise machine-readable information, as is shown in greater detail in FIG. 3. The information ID-1 of the identification module 11 is present either as a two-dimensional matrix code 11a that can be captured by means of a camera 93 of the mobile terminal 9, or else it is stored in an NFC chip 11b that can be read out by means of the NFC reading module 94 of the mobile terminal 9, or else it is located on the identification module 11 as an alphanumeric identification code 11c and can be entered into an input window 92 provided in the mobile terminal, and it is evaluated or captured by the transaction application 4 and transmitted U3 to the transaction server 6. The identification module 11 can be transmitted U10 to the first person 1 through the mail or electronically so it can be printed out by means of the printer 13. Preferably, the identification module 11 is transmitted to the first person 1, together with the plurality of transaction encodings 7-1, 7-2, 7-3, . . . . For this purpose, on the basis of the user data N1, the transaction server 6 can generate an identification module 11 that is either transmitted U10 to the first person 1 electronically by the transaction server 6 or that prompts a generation module 51 to generate the identification module 11, for example, with a chip that is integrated into the identification module 11 as the carrier of the information ID-1 for the identification of the first person 1.

The mobile terminal 9 is configured in such a way that, after the capture E of the information ID-1, it automatically establishes H a connection with the transaction server 6 and automatically transmits U3 the information ID-1 of the identification module 11 to the transaction server 6 by the transaction application 4 in response to the information ID-1 of the identification module 11 captured by means of the mobile terminal 9. The transaction server 6 is configured so that data 70 for the personal identification of the first person 1 is transmitted U4 to the mobile terminal 9 of the second person 2 after the verification V of the first person 1 has been completed by the transaction server 6 on the basis of the information ID-1 captured and transmitted to the transaction server 6. The verification is carried out by means of a comparison of the user data N1 of the first person 1 to the captured information ID-1. For this purpose, the information ID-1 of the identification module is stored in the user data N1 of the first person 1 or is part of the user data N1. The mobile terminal 9 and the transaction application 4 are configured in such a way that, after the receipt of the data 70 for the personal identification of the first person 1, they allow the entry of transaction-relevant data TR into the mobile terminal 9 as well as a transmission U5 of at least this transaction-relevant data TR from the mobile terminal 9 to the transaction server 6. In one embodiment, additional transaction-relevant data such as, for example, the time of day, can be transmitted. The transaction server 6 is configured so that a valid transaction encoding 7-g from among the plurality of transaction encodings 7-1, 7-2, 7-3, . . . associated with the user data N1 of the first person 1 is then transmitted U6 to the mobile terminal 9 in response to the transaction-relevant data TR transmitted U5 to the transaction server 6, and so that the transmitted valid transaction encoding 7-g is marked M in the plurality of stored transaction encodings 7-1, 7-2, 7-3, . . . as a transaction encoding 7-u that is invalid for subsequent transactions. Moreover, the transaction application 4 and the mobile terminal 9 are configured so that at least parts of the transmitted valid transaction encoding 7-g, together with the data 70 for the personal identification of the first person 1, are displayed D on the display element 91 of the mobile terminal 9, so that the displayed transaction encoding 7-g and the data 70 for the personal identification of the first person 1 can be visually compared VG to the plurality of transaction encodings 7 that were transmitted to the first person 1 by the transaction server 6, and thus so that the transaction can be completed AB by the first person 1. The comparison means 10 is used in the cancellation procedure so that a verification of the reversal VR of the specific transaction can be carried out by the transaction server 6. Here, the first and second transaction codes 71, 72 that were transmitted U9 by the mobile terminal 9 are compared to the stored transaction code 7-s that is associated with the user data N1 of the first person 1 and with the cancellation identification code SC, whereby said transaction code 7-s comprises the first and second transaction codes 71, 72 stored for this purpose.

The components of the transaction system T shown here can be configured as separate components that are connected to the transaction server 6 via data lines, or else they can be integrated into the transaction server 6 as sub-components. Depending on the task at hand, the components selected by a person skilled in the art can be processors, data memory units or other types of components. The transaction system T can be configured, for example, as a network with one or more transaction servers 6 having an Internet connection, or it can additionally comprise one or more computers that provide the website 12 (in a web portal) and that are connected to the transaction server(s) 6 and, if applicable, to the additional components of the transaction system T. In a client-server network, the transaction servers 6 are the servers (backend), whereas the computers via which the first and/or second persons operate the website 12 of the transaction system T form the clients (frontend). When the term “transaction server” is used within the scope of this invention, this always includes the possibility of using several transaction servers.

FIG. 2 shows an embodiment of the transaction encodings that are to be transmitted. Here, the transaction encoding 7 comprises data 70 for the personal identification of the first person 1, a first transaction code 71 and a second transaction code 72. Here, the transaction encodings 7 generated in the generating means 5 and transmitted U2 to the first person 1 by using the transaction server 6 differ unambiguously from each other, for example, at least in terms of having different first and/or second transaction codes 71, 72. The transaction codes and the personal identification can be suitably selected by the person skilled in the art, for example, as alphanumeric codes. For purposes of achieving a better recognition of the transaction encodings 7, preferably graphic codes or symbols are used for the personal identification 70, for the first transaction code 71 and for the second transaction code 72. In different embodiments, the plurality of transaction encodings to be transmitted U2 to the first person 1 can comprise a different number of transaction encodings 7-1, 7-2, 7-3, . . . . The number of transaction encodings 7 to be transmitted U2 can be, for example, predetermined in the transaction system T or selected by the first person 1 via the website 12. After the transaction encoding 7-1 has been used for a transaction as a transaction encoding 7-1 that had not yet been used and was thus valid (or after its use led to the refusal of the transaction), this transaction encoding 7-g cannot be used anew for other transactions. Therefore, the transaction encodings that have already been used are marked as invalid transaction encodings 7-u in the transaction encodings 7 and stored in the user database 32. For the next approval of a transaction, one of the remaining transaction encodings 7-2, 7-3, . . . that have been transmitted to the first person are used. This transaction encoding that is now to be used can be the numerically subsequent transaction encoding 7-2 on the list of the transaction encodings that have been transmitted. In this case, the transaction encoding 7-2 constitutes the first transaction encoding for carrying out the method. In another embodiment, the transaction encoding to be used is selected by the transaction server 6, for example, the transaction encoding 7-3. In this case, the transaction encoding 7-3 constitutes the first transaction encoding for carrying out the method. In order to use the transaction encodings 7 in the cancellation procedure, certain identifiers are associated with the transaction encodings 7 and are transmitted as a cancellation identification code SC. In this context, these identifiers can be part of the transaction encoding 7 or can be associated with them separately from the transaction encodings 7 in the list of transmitted transaction encodings 7. This association is likewise stored in the user data N1.

FIG. 3 shows an embodiment of the capture of the information for the identification of the first person on the basis of the identification module. For this purpose, the second person starts A the transaction application 4 on the mobile terminal 9 by means of appropriate entries into an input window 92 in the display element 91. In the case of a two-dimensional matrix code 11a, the machine-readable information ID-1 can be read out by a camera 93 in the mobile terminal 9. Here, this matrix code 11a is displayed as a QR code that consists of a square matrix of black and white dots and that contains a special marking in three of the four corners of the square code. The QR code and corresponding decoder modules can be obtained, for example, from the Denso Wave Company. Moreover, in this embodiment, the identification module comprises an NFC chip 11b that can be read out by means of an NFC reading module 94 in the mobile terminal 9. In addition, in this embodiment, an alphanumeric identification code 11c (for example, “ABCD-12345”) is located on the identification module 11 that is entered by means of the transaction application 4 via an appropriate input window 92 provided for this purpose. The identification module 11 can be a sticker that is suitable to be displayed at the business point 1a of the first person 1. The actuation of the camera 93 of the mobile terminal 9 in order to capture the matrix code 11a is automatically evaluated by the previously started transaction application 4 as a response to the actuation of the camera 93. The second person 2 scans the displayed QR code 11a with the opened transaction application 4. The transaction application reads out the QR code and interprets the information ID-1 as an unambiguous URL to which it establishes a connection. The URL leads to the transaction server 6 that provides the transaction application with the data for the personal identification. If an NFC chip is present, in response to the information ID-1 provided by the NFC chip 11b, the information captured by the NFC reading module 94 of the mobile terminal 9 automatically leads to an evaluation/sending of the information from the previously started transaction application 4. The transmission takes place either connectionless with passive HF-RFID tags according to ISO 14443 or ISO 15693, or via a connection between equivalent active transmitters. Additional security functions for the secure transmission of the information, for example, encrypted information, can be integrated into the hardware of the mobile terminal 9. If the alphanumeric identification code 11c (QR combination) located on the identification module 11 is entered into an input window 92 provided by the transaction application 4, this entry leads to an automatic evaluation of the information ID-1. The evaluation relates to a conversion of the information into a format that is suitable for the transaction server to compare it to the user data. In addition, on the basis of the format, the evaluation checks whether the received or entered data can even be such information. Subsequently, the information 11a, 11b, 11c that has been evaluated or entered on the mobile terminal 9 by the transaction application 4 is transmitted U3 to the transaction server 6. If the information is present in the forms 11a, 11b, 11c, an entry/capture of all three data formats can account for an increased security for the identification of the first person and can allow a correction of transmission errors in one of the data formats.

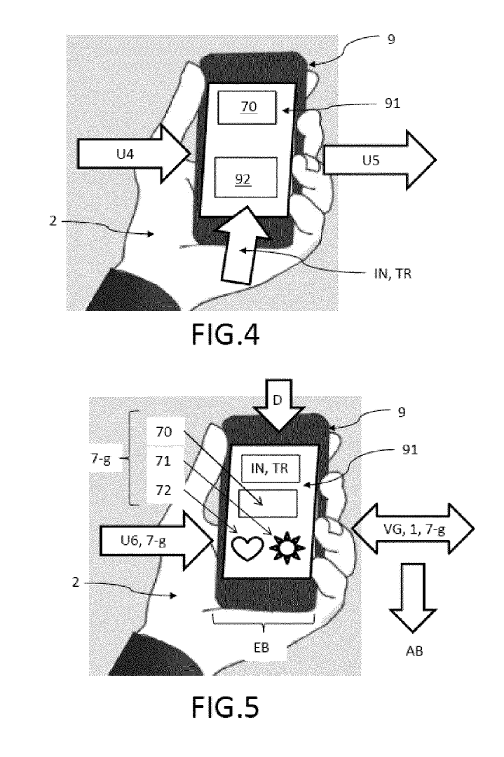

FIG. 4 shows an embodiment of the mobile terminal for entering transaction-relevant data. After the verification V of the first person 1 has been carried out by the transaction server 6 on the basis of the information ID-1 that has been captured E and transmitted to the transaction server 6, data 70 for the personal identification of the first person 1 is transmitted U4 by the transaction server 6 to the mobile terminal 9 of the second person 2, and the transaction-relevant data TR is entered IN into the mobile terminal 9 and, subsequently, after a confirmation of the entry, transmitted U5 by the mobile terminal 9 to the transaction server 6.

FIG. 5 shows an embodiment of the mobile terminal and of the display of the valid transaction encoding at the completion of the transaction. A valid transaction encoding 7-g from among the plurality of transaction encodings 7-1, 7-2, 7-3, . . . is transmitted U6 by the transaction server randomly (arbitrarily) from the user data N1 to the mobile terminal 9 in response to the transaction-relevant data TR transmitted to the transaction server 6, and displayed D, together with the data 70 for the personal identification of the first person 1, on the display element 91 of the mobile terminal 9 by the transaction application 4. In the display, the first and second transaction codes 71, 72 of the transaction encoding 7-g are displayed as simple graphic symbols “heart” and “star”. This permits a fast visual comparison VG of the displayed transaction encoding 7-g to the transaction encodings 7-1, 7-2, 7-3, . . . , which are similarly structured and which have been transmitted by the transaction server 6 to the first person 1. If the valid transaction encoding 7-g is present in the transaction encodings transmitted to the first person, the first person can carry out the completion AB of the transaction, for example, by handing the product that has been paid for with this transaction over to the second person.

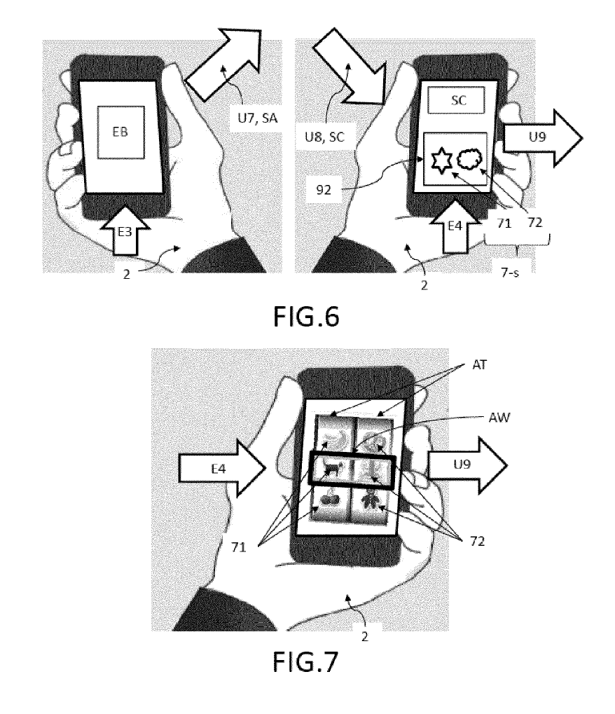

FIG. 6 shows an embodiment of the mobile terminal for the cancellation procedure according to the invention. Here, after the start of the transaction application 4, a cancellation request SA for a specific transaction is transmitted U7 to the transaction server 6 in the form of the appropriate electronic record EB by the transaction application 4 after the appropriate entry E3 on the mobile terminal 9, in response to which the transaction server 6 transmits U8 to the mobile terminal 9 a cancellation identification code SC, for example, a number or a letter, which designates a specific transaction encoding from among the plurality of transaction encodings 7 that had been transmitted to the first person 1. Then the first and second transaction codes 71, 72—here in the form of graphic transaction codes (“star”=71, “cloud”=72)—are entered E4 into the mobile terminal 9 by the first person 1 for the transaction encoding 7-s designated by the cancellation identification code. As a result of the confirmation of the entry in the mobile terminal, the entered first and second transaction codes 71, 72 are transmitted U9 to the transaction server 6.

FIG. 7 shows an embodiment of the transaction codes 71, 72 displayed in the display element 91 of the mobile terminal 9 as well as their selection AW in the display element 91. In this embodiment, the first and second transaction codes 71, 72 are entered E4 by making a selection AW from a number of possible first and second transaction codes 71, 72 that are displayed in the display element 91 and that are arranged in the display element 92 on first and second virtual dials AT that can be used to scroll up and down accordingly. A selection field AW facilitates the correct selection once the first person has indicated the correct transaction codes 71, 72.

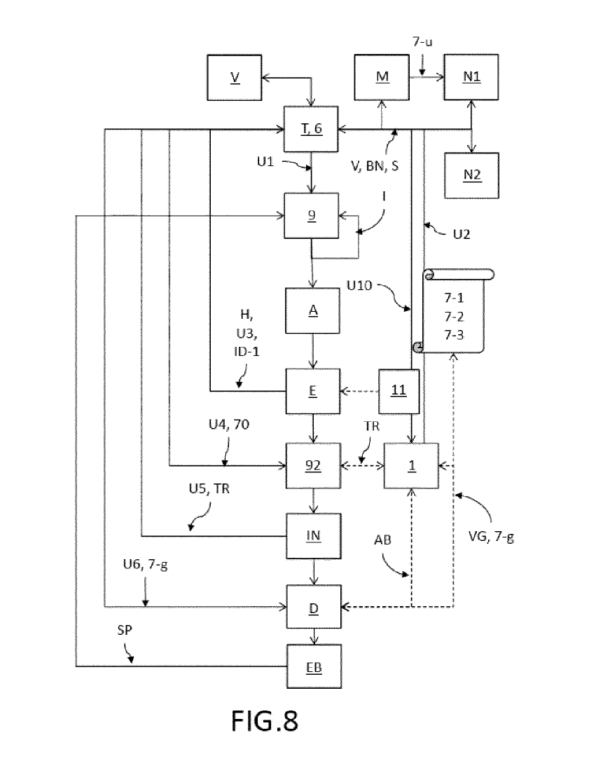

FIG. 8 shows an embodiment of the method according to the invention. Here, at least first user data N1 of the first person 1 and second user data N2 of the second person 2 are provided BN in the transaction system T for purposes of access by the transaction server 6. Moreover, an identification module 11 is provided by the first person 1 at the business point 1a of the first person 1 comprising information ID-1 for the identification of the first person 1. A plurality of transaction encodings 7-1, 7-2, 7-3, . . . is transmitted U2 by the transaction system T to the first person. Preferably, here, each transaction encoding 7 comprises at least a first transaction code 71 and a second transaction code 72, both of which can be configured as graphic codes. Each of the transmitted transaction encodings 7 differs unambiguously from the other transmitted transaction encodings 7. The transmitted plurality of transaction encodings 7 is stored S in the transaction system T and associated with the first user data N1 of the first person 1. Now, the transaction system T is prepared for the execution of a transaction with the transaction application 4, which is now started on the mobile terminal 9 of the second person 2 after having been previously installed I. Preferably, the transaction application 4 is transmitted U1 by the transaction server 6 to the mobile terminal 9. Subsequently, the information ID-1 of the identification module 11 is captured E by means of the mobile terminal 9 of the second person 2, then a connection of the mobile terminal 9 to the transaction server 6 is automatically established, and the information ID-1 of the identification module 11 is automatically transmitted U3 to the transaction server 6 by the transaction application 4 in response to the captured information ID-1 of the identification module 11. Subsequently, data 70 for the personal identification of the first person 1 is transmitted U4 by the transaction server 6 to the mobile terminal 9 of the second person 2. This transmission U4 takes place after a verification V of the first person 1 by the transaction server 6, which is based on a comparison of the user data of the first person 1 to the captured E information ID-1. Subsequent to the received data 70 of the personal identification, now the transaction-relevant data TR is entered IN into the mobile terminal 9 by the second person and, after a confirmation of the entry, this data is automatically transmitted U5 by the transaction application 4 of the mobile terminal 9 to the transaction server 6. In response, the transaction server selects a valid transaction encoding 7-g from the plurality of transaction encodings 7-1, 7-2, 7-3, . . . associated in the transaction system T with the user data N1 of the first person 1, and this transaction encoding 7-g is transmitted U6 to the mobile terminal 9 in response to the transaction-relevant data TR that had been transmitted to the transaction server 6. In parallel, the transmitted valid transaction encoding 7-g is marked M by the transaction server 6 in the plurality of the stored transaction encodings 7-1, 7-2, 7-3, . . . associated with the user data N1 as a transaction encoding 7-u that is invalid for subsequent transactions. The marking can be suitably executed by the person skilled in the art, for example, by setting a checked box or flag for the invalid transaction encoding 7-u, which blocks a renewed transmission thereof. The transmitted transaction encoding 7-g, including the transaction codes 71, 72 contained in it, together with the data 70 for the personal identification of the first person 1, is displayed D on the display element 91 of the mobile terminal 9 by the transaction application 4. This permits a visual comparison VG of the displayed transaction encoding 7-g to the still-valid transaction encodings 7-1, 7-2, 7-3, . . . that had been transmitted by the transaction server 6 to the first person 1. If the comparison VG shows that the displayed D transaction encoding 7-g has not yet been used, the first person 1 completes AB the transaction with the second person 2. The display D is stored as an electronic record EB on the mobile terminal 9. Preferably, the second person confirms the storing SP by actuating an appropriate button that is provided for this purpose by the transaction application.

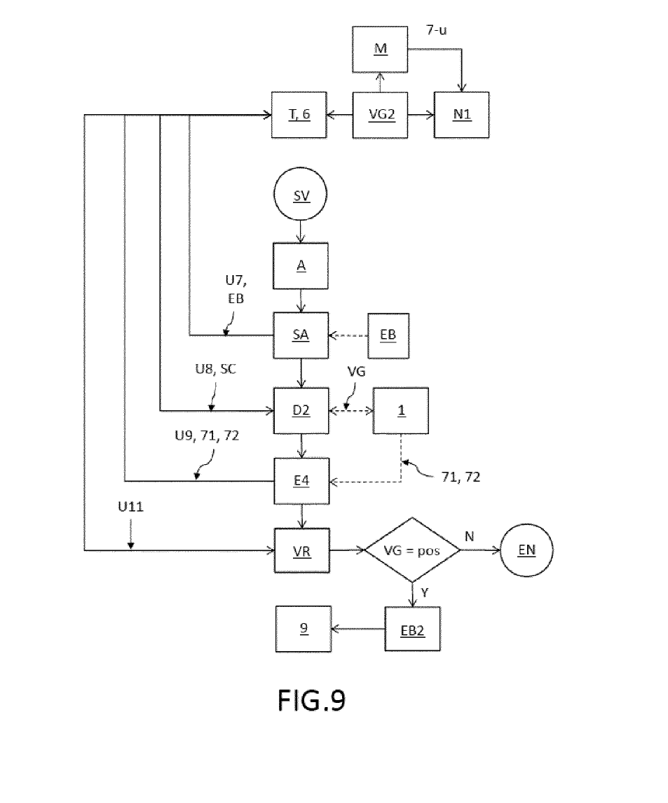

FIG. 9 shows an embodiment of the cancellation procedure SV whose start is represented by the circular field “SV”. With the cancellation procedure SV, the transaction application 4 supports the verified reversal VR of the transaction, making use of one of the still-valid transaction encodings 7-g from among the plurality of transaction encodings 7-1, 7-2, 7-3, . . . transmitted U2 to the first person 1. In this context, the cancellation procedure comprises the transmission U7 of a cancellation request SA for a specific transaction to the transaction server 6 by the transaction application 4 after an appropriate entry E3 on the mobile terminal 9. The person skilled in the art can configure cancellation requests in different ways. In a preferred embodiment, the electronic record EB for the specific transaction is transmitted to the transaction server 6 as the cancellation request SA, since the electronic record unambiguously identifies the appertaining transaction on the basis of the used and stored transaction code. After the transaction server has received the cancellation request via the wireless data connection, the transaction server 6 transmits U8 a cancellation identification code SC, which designates a specific transaction encoding 7 from among the plurality of transaction encodings 7 that had been transmitted to the first person 1, whereby each of the transaction encodings 7 comprises first and/or second transaction codes 71, 72 that unambiguously differ from the first and/or second transaction codes 71, 72 of other transaction encodings 7. The transmitted cancellation identification code SC is displayed D2 by the transaction application after being received, and appropriate first and second transaction codes 71, 72, preferably graphic transaction codes, from the transaction encoding 7-s that is designated by the transmitted cancellation identification code SC are entered E4 into the mobile terminal 9 by the first person 1 on the basis of the plurality of transaction encodings 7-1, 7-2, 7-3, . . . that were transmitted to the first person 1 and that comprise the transaction encoding 7-s that is designated by the cancellation identification code SC, and these transaction codes 71, 72 are subsequently transmitted U9 to the transaction server 6. Then, the first and second transaction codes 71, 72—transmitted U9 by the mobile terminal 9—for the transaction encoding 7-s regarding the cancellation identification code SC are compared VG2 by the transaction server to the stored transaction encoding 7-s associated with the user data N1 of the first person 1 and with the cancellation identification code SC. In case of a positive comparison VG2, the verified reversal VR of the transaction is carried out. The entered E4 transaction codes and the data 70 for the personal identification are stored by the transaction application 4 in the mobile terminal 9 as an electronic record EB2 for the cancellation. In case of a negative comparison VG2, the cancellation procedure is aborted, see the circular final area “EN” in FIG. 9.

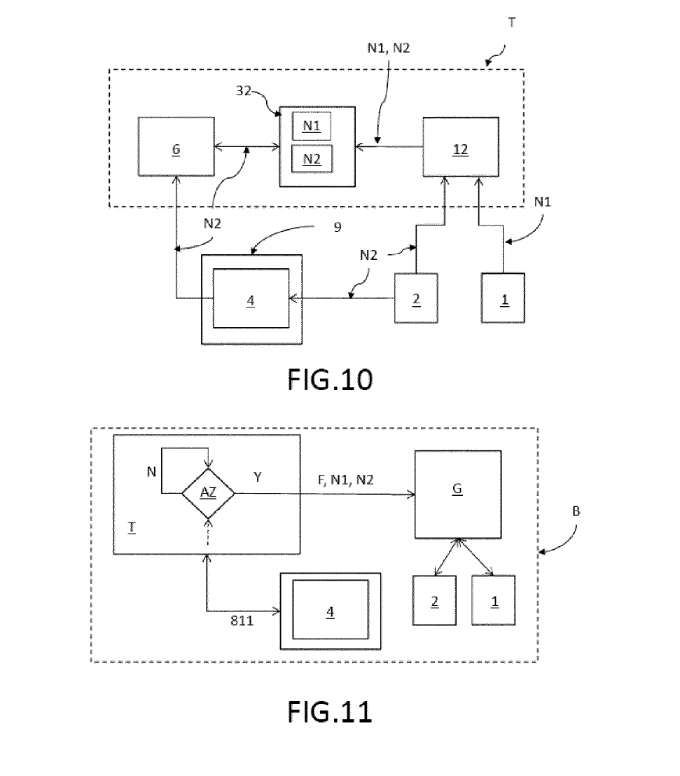

FIG. 10 shows an embodiment of the step of registration R of the first person 1 and the second person 2 in the transaction system T according to the invention in order to generate first user data N1 and second user data N2, whereby the registration R of the first person 1 and the second person 2 can be carried out via a website 12 of the transaction system T in that these persons provide data. This user data N1, N2 is stored in a user database 32 which the transaction server 6 can access via a data connection. As an alternative, the second person can register by running the transaction application 4. Here, after a wireless data connection 811 to the transaction server 6 has been established, a first boot of the transaction application 4 which had been previously installed on the mobile terminal 9 automatically starts the step of registration of the second person 2, and preferably, the contact data for establishing the wireless data connection 811 is automatically transmitted by the transaction application 4 to the transaction server 6. The transaction application was previously downloaded, for example, from an app store, and installed onto the mobile terminal 9. The second user data is received by the transaction server 6 and forwarded to the user database 32 in order to be stored S.

FIG. 11 shows an embodiment of a payment system B having a transaction system T according to the invention and having a money management system G for processing the transaction after the approval F according to the invention. In the payment system B, the transaction system T is connected at least to a mobile terminal 9 and at least to a money management system G via data connections. The data connection to the money management systems G can be configured commensurately. In order to execute the transaction that was approved by the transaction server 6, the first user data N1 and the second user data N2 as well as a corresponding approval F are transmitted by the transaction system T to the money management system G, after which, in response to this transmission, the money management system G executes the transaction according to the first user data N1 and the second user data N2. Here, the approval also includes the transaction-relevant data TR that comprises, for example, the amount to be paid. In the embodiment shown here, the transaction system T only transmits the approval F to the money management system G after the expiration AZ of a time interval that is defined in the transaction system T, insofar as no reversal VR of the transaction was transmitted to the transaction server 6 within the time interval on the basis of the cancellation procedure SV according to the invention. The money management system transmits notifications to the first and second persons regarding the executed transactions that were approved by the transaction system. In one embodiment, the information that is transmitted to the first person 1 is configured in such a way that the first person 1 can keep an electronic cash book containing the amounts of the approved transactions and their booking into the money management system G. For this purpose, as is the case for the registration with the transaction system T, the first person 1 needs Internet access with the appropriate hardware. Preferably, the electronic cash book is provided to the first person 1 via the website 12 of the transaction system T.

The embodiments shown here are merely examples of the present invention and consequently must not be construed in a limiting manner. Alternative embodiments taken into consideration by the person skilled in the art are likewise encompassed by the scope of protection of the present invention.

### LIST OF REFERENCE NUMERALS

1 first person
1a business point of the first person
11 identification module
11a matrix code
11b NFC chip
11c alphanumeric identification code
2 second person
31 application memory
32 user database
4 transaction application
5 generating means for the transaction encodings
51 generation module for the identification module
6 transaction server
7 transaction encodings
7-g valid transaction encoding
7-u invalid transaction encoding
7-s transaction encoding designated by the cancellation identification code
7-1 first transaction encoding
7-2 second transaction encoding
7-3 third transaction encoding
70 data for the personal identification
71 first transaction code
72 second transaction code
7A transaction codes that can be selected on the mobile terminal
81 data transmission means (mobile terminal—transaction server)
811 wireless data connection between the mobile terminal and the transaction server
82 data transmission means (transaction system—first person)
821 data connection between the transaction server and the printer of the first person
9 mobile terminal
91 display element of the mobile terminal
92 input field in the display element
93 camera of the mobile terminal
94 NFC reading module of the mobile terminal
10 comparing means (to compare 7-s to 7-1, 7-2, 7-3, . . . )
12 website of the transaction system
13 printer of the first person
A start of the transaction application
AB completion of the transaction by the first person
AD printing out the plurality of transaction encodings by the first person
AT scrollable virtual dials for selecting transaction codes
AW selection of the first and second transaction codes
AZ expiration of the time interval
B payment system
BN provision of user data
BI provision of the identification module
D display of the transmitted part of the first transaction encoding on the display element of the mobile terminal
D2 display of the cancellation identification codes in the display element
E capture of the information of the identification module
E2 entry of the alphanumeric identification codes into the mobile terminal
E3 entry of the cancellation request into the mobile terminal
E4 entry of the transaction encoding designated by the cancellation identification code
EB electronic record of the transaction
EB2 electronic record of a completed reversal of the transaction (cancellation)
F approval of the transaction
G money management system
H establishment of a connection (mobile terminal—transaction server)
I installation of the transaction application on the mobile terminal
ID-1 information for the identification of the first person
IN entry of transaction-relevant data
M marking a transmitted valid transaction encoding in the transaction system as invalid
N1 first user data
N2 second user data
R registration of the first and second persons in the transaction system
S storing the transmitted transaction encodings and associating them with the first user data
SA cancellation request
SC cancellation identification code
SP storage of the electronic record on the mobile terminal
SV cancellation procedure
T transaction system
TR transaction-relevant data
U1 transmission of the transaction application to the mobile terminal
U2 transmission of a plurality of transaction encodings to the first person
U3 transmission of the information ID-1 from the mobile terminal to the transaction server
U4 transmission of data for the personal identification of the first person to the mobile terminal
U5 transmission of transaction-relevant data to the transaction server
U6 transmission of a valid transaction encoding from the transaction server to the mobile terminal
U7 transmission of the cancellation request to the transaction server
U8 transmission of the cancellation identification code from the transaction server to the mobile terminal
U9 transmission of the first and second transaction codes entered in the cancellation procedure from the mobile terminal to the transaction server
U10 transmission of the identification module to the first person
U11 transmission of the verification of the reversal (result of the comparison VG2) to the mobile terminal of the second person
V verification of the first person on the basis of the captured information ID-1
VG comparison of the displayed transaction encodings to the transaction encodings present with the first person
VG2 comparison of the entered first and second transaction codes to the first and second transaction codes that are stored in the transaction server for the transaction encoding designated in the cancellation procedure
VR verified reversal of the transaction/verification of the reversal

1-21. (canceled)

22. An electronic method to securely approve a transaction within the scope of a business transaction at a business point between at least a first person and a second person only via a mobile terminal belonging to the second person and having a display element, irrespective of the technical equipment of the first person at the business point, said method comprising the following steps:
providing at least first user data of the first person as well as second user data of the second person in a transaction system for purposes of access by a transaction server,
providing an identification module by the first person at a business point (1a) of the first person, comprising information for the identification of the first person,
transmitting a list containing a plurality of transaction encodings to the first person by the transaction system, whereby each of the transmitted transaction encodings differs unambiguously from the other transmitted transaction encodings,
storing the list of the transaction encodings in the transaction system and associating the transmitted plurality of transaction encodings with the first user data of the first person,
starting a transaction application that is installed on the mobile terminal of the second person,
capturing the information of the identification module by means of the mobile terminal and automatically establishing a connection between the mobile terminal and the transaction server, whereby only the mobile terminal at the business point is connected to the transaction server of the transaction system via a wireless data connection for purposes of exchanging data in order to approve the transaction, and automatically transmitting the information of the identification module to the transaction server by the transaction application in response to the captured information of the identification module,
transmitting data for the personal identification of the first person by the transaction server to the mobile terminal of the second person after having completed the verification of the first person by the transaction server on the basis of the information transmitted to the transaction server,
entering transaction-relevant data into the mobile terminal and transmitting at least this transaction-relevant data by the mobile terminal to the transaction server,
transmitting a valid transaction encoding from among the plurality of transaction encodings associated in the transaction system with the user data of the first person by the transaction server to the mobile terminal in response to the transaction-relevant data transmitted to the transaction server,
marking the transmitted valid transaction encoding by the transaction server in the plurality of the stored transaction encodings associated with the user data as a transaction encoding that is invalid for subsequent transactions,
displaying at least parts of the transmitted valid transaction encoding, together with the data for the personal identification of the first person, on the display element of the mobile terminal by the transaction application in order to allow the displayed transaction encoding and the data for the personal identification of the first person to be visually compared to the transaction encodings transmitted to the first person by the transaction server.

23. The method according to claim 22, wherein the information for the identification of the first person that is provided by the identification module comprises machine-readable information.

24. The method according to claim 23, wherein the machine-readable information is a two-dimensional matrix code that can be read out by a camera in the mobile terminal and/or an NFC chip that can be read out by an NFC reading module in the mobile terminal.

25. The method according to claim 24, wherein the identification module is a sticker that is suitable to be displayed at the business point of the first person.

26. The method according to claim 25, wherein the sticker comprises the matrix code on the surface of the sticker and/or an NFC chip in or on the sticker and/or an alphanumeric identification code that can be entered into the mobile terminal.

27. The method according to claim 26, further comprising
either photographing the information of the identification module as a two-dimensional matrix code by actuating the camera of the mobile terminal, and automatically evaluating the photographed matrix code by the previously started transaction application in response to the actuation of the camera, or else
reading out the information of the identification module from the NFC chip by means of the NFC reading module of the mobile terminal, and said information is automatically evaluated by the previously started transaction application in response to the information provided by the NFC chip, or else
entering the alphanumeric identification code located on the identification module into an input window provided by the transaction application, and
transmitting the information evaluated or entered on the mobile terminal by the transaction application to the transaction server.

28. The method according to claim 22, further comprising displaying at least parts of the transaction encoding together with the data for the personal identification of the first person, on the display element of the mobile terminal and stored as an electronic record of the transaction, at least by the transaction application, on the mobile terminal of the second person.

29. The method according to claim 28, wherein the first and second transaction codes of the transaction encoding are displaying as parts of the transaction encoding.

30. The method according to claim 28, wherein the transaction application permits the verified reversal of the transaction by providing a cancellation procedure using one of the still-valid transaction encodings from the plurality of transaction encodings that were transmitted to the first person.

31. The method according to claim 30, wherein the cancellation procedure comprises the following steps:
transmitting a cancellation request for a specific transaction by the transaction application to the transaction server, after an entry to this effect has been made on the mobile terminal,
transmitting a cancellation identification code that relates to a specific transaction code among the plurality of transaction encodings transmitted to the first person, whereby each of the transaction encodings comprises first and second transaction codes that unambiguously differ from the first and/or second transaction codes of other transaction encodings, and displaying this cancellation identification code in the display element,
entering the first and second transaction codes of the transaction encoding designated by the transmitted cancellation identification code into the mobile terminal by the first person on the basis of the plurality of transaction encodings that were transmitted to the first person and that comprise the transaction encoding designated by the cancellation identification code,
transmitting the entered first and second transaction codes to the transaction server,
verifying the reversal of the specific transaction by the transaction server by comparing the first and second transaction codes transmitted by the mobile terminal to the stored transaction encoding that comprises the first and second transaction codes stored for this purpose and that is associated with the user data of the first person and with the cancellation identification code, and
reversing the transaction in case of a positive comparison by generating a cancellation credit.

32. The method according to claim 31, further comprising transmitting the electronic record for the specific transaction to the transaction server as the cancellation request.

33. The method according to claim 31, wherein the first and second transaction codes are entered by making a selection from a number of possible first and second transaction codes that are displayed in the display element.

34. The method according to claim 33, wherein the first and second transaction encodings are each arranged in the display element on first and second virtual dials that can be used to scroll up and down accordingly.

35. The method according to claim 1, comprising the additional step of carrying out a registration of at least the first and second persons in the transaction system in order to generate first and second user data.

36. The method according to claim 35, wherein the registration of at least the first person is carried out via a website of the transaction system, whereby at least the first person provides data.

37. The method according to claim 35, wherein a first boot of the transaction application installed on the mobile terminal automatically starts the step of registration of the second person once a wireless data connection to the transaction server has been established.

38. The method according to claim 37, wherein contact data for establishing the wireless data connection are automatically transmitted by the transaction application to the transaction server.

39. The method according to claim 35, wherein the transaction system automatically generates the plurality of transaction encodings for the registered first person for transmission to the first person.

40. The method according to claim 39, wherein the plurality of transaction encodings transmitted by the transaction system to the first person are printed out on a printer of the first person.

41. The method according to one of claim 22, wherein the list of transaction encodings is transmitted to the first person in paper form via regular mail.

42. A non-transitory machine readable medium, where a transaction application suitable for being carried in conjunction with a transaction system is stored, the transaction application being installable on a mobile terminal having a display element and being executable by the mobile terminal, where the mobile terminal can be connected to a transaction server of a transaction system to securely approve a transaction within the scope of a business transaction at a business point between at least a first person and a second person, only via the mobile terminal of the second person irrespective of the technical equipment of the first person at the business point, the transaction system comprising an application memory for storing a transaction application, a user database for storing at least first user data of the first person and second user data of the second person, a generating means for generating transaction encodings, at least one identification module for providing information for the identification of the first person at the business point of the first person, and comprising a transaction server that is connected via data lines at least to the application memory, to the user database and to the generating means, and that can be connected to the mobile terminal of the second person, whereby the mobile terminal is configured in such a way that, after the start of the transaction application installed on the mobile terminal, it captures the information of the identification module and automatically establishes a connection with the transaction server and automatically transmits the information of the identification module to the transaction server by the transaction application in response to the information of the identification module captured by means of the mobile terminal, after which the transaction server is configured to transmit data for the personal identification of the first person to the mobile terminal after the verification of the first person has been completed by the transaction server on the basis of information transmitted to the transaction server, the mobile terminal and the transaction application are configured to permit the entry of transaction-relevant data into the mobile terminal as well as the transmission of at least this transaction-relevant data from the mobile terminal to the transaction server, the transaction server is configured so that a valid transaction encoding from among the plurality of transaction encodings that are stored as a list in the transaction system and that are associated with the user data of the first person is transmitted to the mobile terminal in response to the transaction-relevant data that was transmitted to the transaction server, and to mark the transmitted valid transaction encoding in the plurality of stored transaction encodings as a transaction encoding that is invalid for subsequent transactions, and the transaction application and the mobile terminal are configured to display at least parts of the transmitted valid transaction encoding, together with the data for the personal identification of the first person, on the display element of the mobile terminal, so that the displayed transaction encoding and the data for the personal identification of the first person can be visually compared by the first person to the plurality of transaction encodings that were transmitted to the first person by the transaction server.

43. A mobile terminal comprising a display element and a transaction application installed on the mobile terminal and executable by the mobile terminal, where the mobile terminal can be connected to a transaction server of a transaction system to securely approve a transaction within the scope of a business transaction at a business point between at least a first person and a second person, only via the mobile terminal of the second person irrespective of the technical equipment of the first person at the business point, the transaction system comprising an application memory for storing a transaction application, a user database for storing at least first user data of the first person and second user data of the second person, a generating means for generating transaction encodings, at least one identification module for providing information for the identification of the first person at the business point of the first person, and comprising a transaction server that is connected via data lines at least to the application memory, to the user database and to the generating means, and that can be connected to the mobile terminal of the second person, whereby the mobile terminal is configured in such a way that, after the start of the transaction application installed on the mobile terminal, it captures the information of the identification module and automatically establishes a connection with the transaction server and automatically transmits the information of the identification module to the transaction server by the transaction application in response to the information of the identification module captured by means of the mobile terminal, after which the transaction server is configured to transmit data for the personal identification of the first person to the mobile terminal after the verification of the first person has been completed by the transaction server on the basis of information transmitted to the transaction server, the mobile terminal and the transaction application are configured to permit the entry of transaction-relevant data into the mobile terminal as well as the transmission of at least this transaction-relevant data from the mobile terminal to the transaction server, the transaction server is configured so that a valid transaction encoding from among the plurality of transaction encodings that are stored as a list in the transaction system and that are associated with the user data of the first person is transmitted to the mobile terminal in response to the transaction-relevant data that was transmitted to the transaction server, and to mark the transmitted valid transaction encoding in the plurality of stored transaction encodings as a transaction encoding that is invalid for subsequent transactions, and the transaction application and the mobile terminal are configured to display at least parts of the transmitted valid transaction encoding, together with the data for the personal identification of the first person, on the display element of the mobile terminal, so that the displayed transaction encoding and the data for the personal identification of the first person can be visually compared by the first person to the plurality of transaction encodings that were transmitted to the first person by the transaction server.

44. The mobile terminal according to claim 43, further comprising a camera that is suitable for photographing two-dimensional matrix codes and/or an NFC reading module that is suitable for reading out an NFC chip.

45. A transaction system to securely approve a transaction within the scope of a business transaction at a business point between at least a first person and a second person, only via a mobile terminal of the second person having a display element, irrespective of the technical equipment of the first person at the business point, comprising an application memory for storing a transaction application, a user database for storing at least first user data of the first person and second user data of the second person, a generating means for generating transaction encodings, at least one identification module for providing information for the identification of the first person at the business point of the first person, and comprising a transaction server that is connected via data lines at least to the application memory, to the user database and to the generating means, and that can be connected to a mobile terminal of the second person, and that is configured
to provide at least the first and second user data,
to use suitable data transmission means to transmit a list containing a plurality of generated transaction encodings to the first person, whereby each of the transmitted transaction encodings differs unambiguously from the other transmitted transaction encodings, and
to establish a wireless data connection at the business point only with the mobile terminal of the second person,
whereby the mobile terminal is configured in such a way that, after the start of the transaction application installed on the mobile terminal, it captures the information of the identification module and automatically establishes a connection with the transaction server and automatically transmits the information of the identification module to the transaction server by the transaction application in response to the information of the identification module captured by means of the mobile terminal, after which the transaction server is configured to transmit data for the personal identification of the first person to the mobile terminal after the verification of the first person has been completed by the transaction server on the basis of information transmitted to the transaction server,
the mobile terminal and the transaction application are configured to permit the entry of transaction-relevant data into the mobile terminal as well as the transmission of at least this transaction-relevant data from the mobile terminal to the transaction server,
the transaction server is configured so that a valid transaction encoding from among the plurality of transaction encodings that are stored as a list in the transaction system and that are associated with the user data of the first person is transmitted to the mobile terminal in response to the transaction-relevant data that was transmitted to the transaction server, and to mark the transmitted valid transaction encoding in the plurality of stored transaction encodings as a transaction encoding that is invalid for subsequent transactions, and
the transaction application and the mobile terminal are configured to display at least parts of the transmitted valid transaction encoding, together with the data for the personal identification of the first person, on the display element of the mobile terminal, so that the displayed transaction encoding and the data for the personal identification of the first person can be visually compared by the first person to the plurality of transaction encodings that were transmitted to the first person by the transaction server.

46. The transaction system according to claim 45, wherein the transaction server is configured to use suitable data transmission means to transmit the transaction application to the mobile terminal of the second person.

47. The transaction system according to claim 45, further comprising a website for at least the first person to be registered in the transaction system and for data to be entered at least by the first person in order to generate first user data.

48. The transaction system according to claim 45, further comprising a payment system having at least one money management system that is connected to the transaction system in order to execute the transaction between the first and second persons after approval by the transaction system, whereby the approval is sent to the money management system by the transaction system in response to the valid transaction encoding transmitted to the mobile terminal.
